(19) United States
(12) Patent Application Publication
(10) Pub. No.: US 2002/0187836 A1
(43) Pub. Date: Dec. 12, 2002

(54) Gaming system

(76) Inventor: Jason Meyer, Wollstonecraft (AU)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/165,329

(22) Filed: Jun. 7, 2002

(30) Foreign Application Priority Data
Jun. 8, 2001 (AU) PR5590

(51) Int. Cl. A63F 13/00

(52) U.S. Cl. 463/42

(57) ABSTRACT

A gaming system with a number of linked gaming machines (1 to 6) which independently operate a primary game of chance until a trigger initiates a feature (8) in all eligible machines via a central controller (7).

### BACKGROUND OF THE INVENTION

The present invention relates to gaming machines. The invention has been developed primarily for computerized gaming machine systems and will be described herein with specific reference to that application. However, it will be appreciated that the invention is not limited to these types of gaming machine systems and would equally apply to other applications such as gaming systems facilitated via the Internet.

Gaming machines have long been known and are now one of the most common forms of gambling. One of the oldest and best known forms of gaming machine is the rotating reel type “poker machine”. These machines use a series of three or more reels, each having symbols on the peripheral edge. The reels are rotated upon placing a bet and then stopped to produce a randomly selected arrangement of symbols. Winnings are paid if the random arrangement of symbols matches one of the predetermined winning combinations.

Recently these gaming machines have been computerized with a video display replacing the physically rotating reels. The display screen typically presents an array of symbols in five columns and three rows equating to the symbols that would normally be seen on the five rotating reels of the old style mechanical machines. Computerized machines have allowed players to bet on the symbols appearing in one or more rows or columns, instead of just the line of symbols across the middle row which was the traditional practice of the old style mechanical machines. Eventually, all the practical “paylines” of symbols available in the array were being used in computerized gaming machines.

In an ongoing effort to further enhance the gaming experience, gaming machines provided secondary games of a different nature to the primary game. The secondary games are often referred to “features”. The feature would appear upon some trigger event such as a predetermined outcome in the primary game. The feature offers the player some variety in the gaming experience and it also provides the game designer with an opportunity to award the player with significant winnings as an incentive to continue playing the machine.

Jackpot systems are also used as an incentive to encourage the players. A jackpot amount is shown on a screen near a selected group of gaming machines. The jackpot amount slowly increases in accordance with the bets placed on each of the machines in the group. A microprocessor linked to the machines randomly selects a certain jackpot value which remains unknown until it is won. The jackpot is awarded to the machine that places the bet that causes the jackpot amount shown on the screen to reach the unknown or ‘mystery’ jackpot value.

This provides a significant sense of bonus for the player that wins the jackpot amount. However, the players using the remaining machines in the group are aware that the process of slowly incrementing the jackpot value towards another randomly selected amount will begin again. At this point, the incentive provided by the jackpot is diminished and some players may chose to stop gaming.

### SUMMARY OF THE INVENTION

In accordance with the present invention, there is provided a gaming machine which overcomes or ameliorates at least one of the disadvantages of prior gaming machines and provides a useful alternative.

Further, in accordance with the present invention, there is provided a gaming system comprising:

at least two gaming machines, wherein each gaming machine comprises means adapted to display a primary game having random outcomes including predetermined winning outcomes and means adapted to accept a bet on the occurrence of at least one the winning outcome and pay winnings on the occurrence of any of the winning outcomes carrying a bet; and

a controller linked to each of the gaming machines for initiating a feature game in at least one of the gaming machines in response to a trigger wherein only the gaming machines that satisfy certain eligibility criteria receive the feature game.

comprising at least two gaming machines, wherein each gaming machine comprises

By linking a group of gaming machines and allowing each machine that is currently being played to participate in a high yielding feature, even though it was triggered by one of the other machines, all the players within the group are given a strong incentive to keep playing.

Preferably, the winnings awarded to at least one of the gaming machines are dependent on its outcome at the conclusion of the feature game, relative to the outcomes of the other gaming machines. In a further preferred form, winnings awarded to each of the gaming machines are determined by the respective outcomes of each machine relative to the others.

In some embodiments, the feature game is a series of individual game events that initiate and operate independently on each of the gaming machines, such that the outcome of the feature game is the accumulated total of the winnings from the series of individual game events, wherein the controller adjusts the winnings for one or more of the machines depending on the outcome of each machine relative to the others. The adjustment may be a bonus awarded by the controller at predetermined milestones during the series of individual game events, in accordance with the progressive accumulation of winnings of each machine relative to the others. This form of the present invention allows the system to award bonuses to the player that has the highest “score” or accumulated credits at, for example, the half way point of the feature.

Preferably, the bonus awarded by the controller is in the form of certain amounts of additional winnings, such as a proportion of a variable amount set by the controller as a competition feature win. For example, a set amount of additional winnings may be awarded to the machine that has the highest progressive total of winnings halfway through the series of individual game events, and the competition feature win is proportionally divided between the machines with the three highest accumulated totals at the end of the series.

Of course, the individual game events may be on screen simulations of black jack, popular dice games or just the standard five reel, three row of array of symbols typical of many poker machines.

Preferably, the eligibility criteria by which the controller assesses which of the machines can participate in the feature are whether the machine is operating a game at the time of the trigger or less than 10 seconds has elapsed since the end of the last game, and the machine still carries player credit for continued operation.

This ensures that only the currently operational gaming machines are participating in the feature game. Furthermore, the 10 seconds time limit ensures that a player will not simply sit at the machine and wait until another player triggers the feature game.

In some preferred embodiments, a percentage of the bet placed on each machine is recorded by the controller and the progressive accumulation of the percentage of the bets from all the machines is shown as the competition feature win amount on a large screen in a prominent position near the machines, wherein the competition feature win amount is initially set at a minimum value and increases whenever a bet is placed on at least one of the machines linked to the controller, such that when the accumulated competition feature win value reaches a randomly selected trigger value, the controller initiates the feature game. During the feature game, the large screen shows a progressive total of the feature game winnings for each of the eligible machines. Each of the eligible machines show the progressive totals of the feature game winnings during the feature game. The large screen, and each of the eligible machines, show regular updates of the feature game winnings, the number of individual game events remaining in the feature game, and a ranking of the eligible machines. Each of the eligible machines have individualized displays highlighting its own position relative to the other eligible machines.

The system may be configured so that at the conclusion of the feature game, the machine with the most feature game winnings is awarded 75% of the trigger value and the machine with the next highest winnings is awarded 25% of the trigger value, unless only one of the machines were eligible to participate in the feature game. In that case, 100% of the trigger value is awarded to the machine. If two or more of the machines have equal highest feature game winnings, then the trigger value is split equally between the tied machines. If two or more machines tie for the second highest feature game winnings and only one machine has the highest feature game winnings, then 25% of the trigger value is divided equally amongst these machines.

In another variation, the feature game winnings for each machine may be adjusted depending on the last amount bet on the primary or base game immediately prior to the initiation of the feature game.

In some embodiments, at least one of the eligible machines are excluded from the feature game as it progresses. Preferably, after a predetermined number of the individual game events, the controller excludes at least one of the machines with the lowest progressive total until only two of the machines remain which complete the feature game, wherein the winner receives 75% of the trigger value and the other receives 25%. Alternatively, after predetermined number of individual game events, the controller excludes any of the machines that fail to reach a threshold level of winnings. Preferably, the eligible machines play to achieve an escalating series of winning thresholds that must be achieved within a set number of the individual game events, otherwise the controller excludes those machine from the feature game. In a further preferred form, each of the thresholds has a bonus that is awarded to each machine that achieves that threshold. In a particular preferred form, if none of the machines meet one of the thresholds the unclaimed bonuses are added to the bonuses available when the feature game next operates.

These and other advantages, aspects, and features will be understood by one of ordinary skill in the art upon the reading and understanding of the specification.

### BRIEF DESCRIPTION OF THE DRAWINGS

A preferred embodiment of the present invention will now be described, by way of example only, with reference to the accompany drawings in which:

FIG. 1 shows a schematic representation of a gaming system according to the present invention; and

FIG. 2 shows a schematic representation of the system shown in FIG. 1 operating in a linked feature mode.

### DETAILED DESCRIPTION OF THE PREFERRED EMBODIMENT

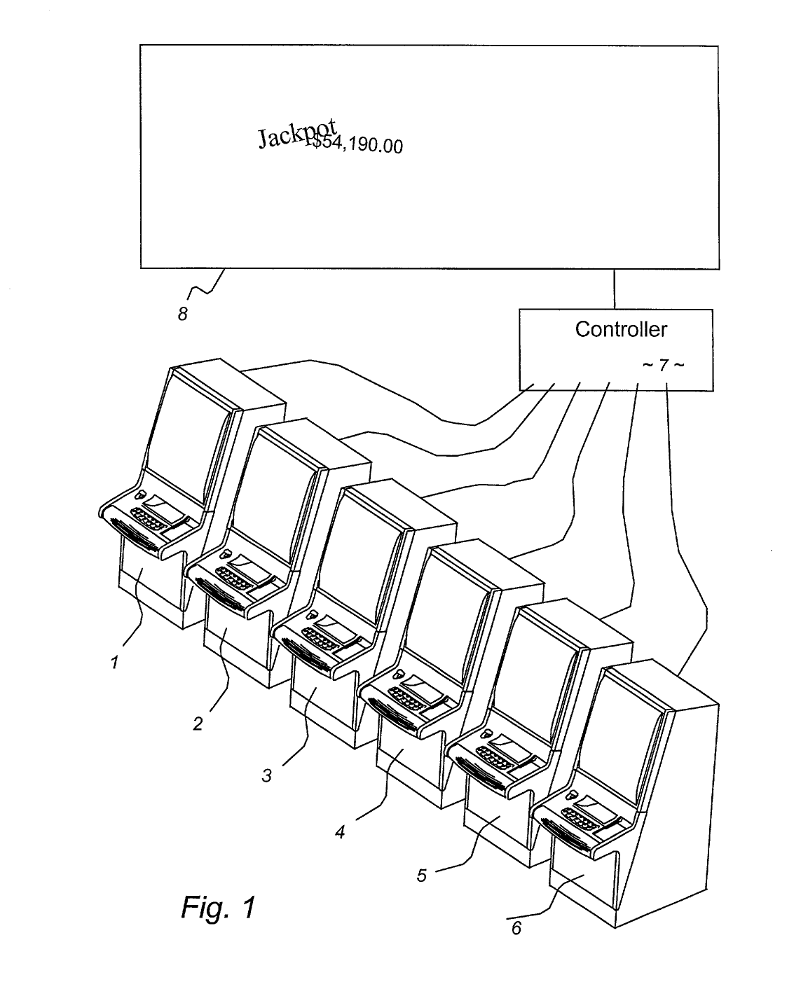

Referring to FIG. 1, a bank of six adjacent machines 1, 2, 3, 4, 5 and 6 are linked to a central controller 7 and a large overhead video display screen 8. A predetermined trigger event in any one of the gaming machines initiates the feature game in all the machines 1 to 6 that satisfy pre-set eligibility criteria. The embodiment shown in FIG. 1 uses a mystery competition feature win amount whereby all the bets placed on the linked machines are added to an accumulated total shown on the overhead screen 8. The controller randomly selects a mystery competition feature win value somewhere between set minimum and maximum values.

When one of the machines causes the accumulated competition feature win value to reach the mystery value, the feature game is initiated in all eligible machines. To be eligible, the gaming machine must be playing a game at the time of the trigger, or, have current credit and has not had more than 10 seconds elapse since the completion of its last game. This prevents machines that are not currently being used from participating in the feature and also prevents any players from occupying a machine without playing, or playing infrequently, in attempt to gain the advantage of a feature game triggered by one of the other machines. During the feature game the non-eligible machines may still be played, however, they will not be able to trigger a new feature game until the completion of the current feature game.

Each of the eligible or qualifying machines will automatically switch to the feature game mode after the trigger has occurred and the last game or ensuing “double up”, “rack up” and so on has been completed. A “double up” is a common part of many typical gaming machines where the player is given the opportunity to double any wins from a single operation of the primary game. It does this using a simple game of chance with a 50% likelihood of success, for example, choosing whether a face down card is either red or black. Similarly, many typical poker machines offer a “quadruple up” option where the player can pick the suit a face down card shown on the screen. A “rack up” is a common technique used to emphasize any winnings being added to the accumulated total shown on a machine. The win meter which tallies the current winnings drops to zero and then rapidly increases from 0 to the total win amount so that the player can visualize the rapidly increasing tally on the win meter.

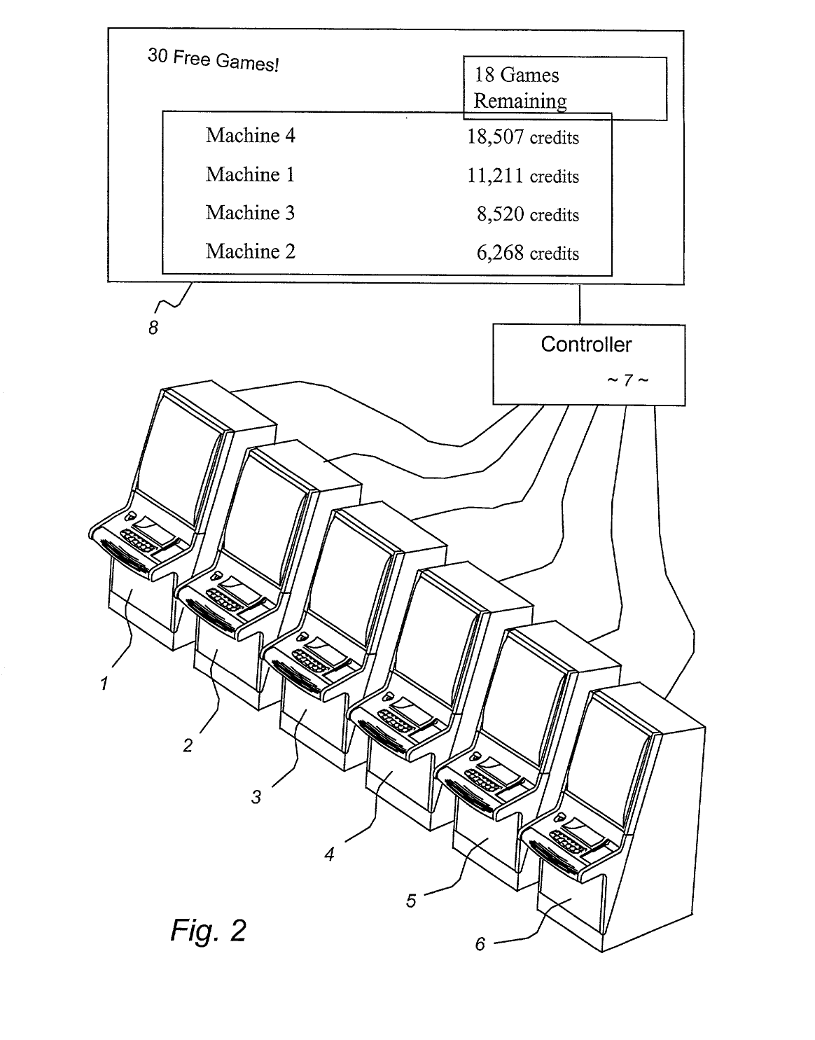

As shown FIG. 2, only gaming machines 1, 2, 3 and 4 were eligible to participate in the feature game. In this example, the feature game is a series of thirty free games for each machine. The games can be of any convenient types such as the typical five rotating reel poker machine games, dice games, card games and so on. If the feature is a series of free “spins” of a typical five reel poker machine game, then each of the eligible machines will need to be playing all of the available pay lines. If not, then any machines that are playing more pay lines than others will have a clear advantage. To address this, each of the machines may be configured so that the maximum number of available pay lines are played during the base game thereby ensuring that the same number of pay lines are being played during the feature game.

The overhead video screen 8 displays a leader board showing the current winnings from each machine. Each machine will need to be clearly labeled with a name. It would be convenient to base the name of the each machine on the particular theme of the base game. Alternatively, the names for each machines may be assigned at random each time the feature game triggers.

The controller 7 regularly updates the leader board and arranges the machines so that they are ranked against one another according to their current winnings from the feature game. The screen 8 also shows the number of free games completed by each machines and the number of free games remaining for each machine.

At the conclusion of the feature game, the gaming machine with the most winnings is awarded 75% of the mystery competition feature win. The machine with the next highest winnings is awarded 25% of the mystery competition feature win. All participating games get to retain the winnings during the feature game for use in the primary or base game.

If only one machine is eligible for the feature game, then that machine wins 100% of the competition feature win. If two or more machines tie for the highest accumulated winnings during the feature game then the competition feature win is divided equally between each of them. Of course, in this case, the machine with the second highest winnings will not receive a proportion of the competition feature win. If one machine has the highest winnings and two or more machines tie for the second highest winnings at the conclusion of the feature game, 25% of the competition feature win is divided equally between the tied machines.

All gaming machines must, over time, retain a small percentage of the bets received in order to operate at a profit. In the present invention, the proportion of the total winnings available should be carefully divided between the primary game and the feature game in order to maintain the players interest. Typically, a gaming machine will return approximately 90% of the bets received as winnings. Of this 90%, about 60% should come from the primary game, about 20% should come from winnings from the free games during the feature game, and about 10% should come from winning any jackpot amounts or other bonuses.

Other alternatives of the feature game can involve a competition that excludes eligible machines as it progresses. One embodiment would be to award each of the eligible machines five free games at the end of which the two lowest scoring eligible gaming machines are excluded from the feature game. The remaining eligible machines are awarded another five games. The process is repeated until ultimately the remaining machines play off for first and second prizes.

In another embodiment, the eligible machines may be set a minimum threshold of winnings that they must achieve within say ten free games. Any of the eligible games that fail to meet the threshold are excluded from the next allotment of free games. During the next set of free games, the remaining machines must aim for a higher threshold. This can continue until a prize level is reached where any machines that reach this level share in the competition feature win amount. If all of the eligible machines fail to achieve the prize level, it is added to the competition feature win amount available during the next feature game.

The present invention has been defined herein by way of example only. The ordinary workers in this field will readily recognize many variations and modifications which do not depart from the spirit of the scope of the broad inventive concept. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A gaming system comprising:
at least two gaming machines, wherein each gaming machine comprises means adapted to display a primary game having random outcomes including predetermined winning outcomes and means adapted to accept a bet on the occurrence of at least one of the winning outcomes and pay winnings on the occurrence of any of the winning outcomes carrying a bet; and
a controller linked to each of the gaming machines for initiating a feature game in at least one of the gaming machines in response to a trigger wherein only the gaming machines that satisfy certain eligibility criteria receive the feature game.

2. A gaming system according to claim 1 wherein the winnings awarded to at least one of the gaming machines are dependent on its outcome at the conclusion of the feature game relative to the outcomes of the other gaming machines.

3. A gaming system according to claim 2 wherein winnings awarded to each of the gaming machines are determined by the respective outcomes of each machine relative to the others.

4. A gaming system according to claim 1 wherein the feature game is a series of individual game events that initiate and operate independently on each of the gaming machines such that the outcome of the feature game is the accumulated total of the winnings from the series of individual game events and wherein the controller adjusts the winnings for at least one of the machines depending on the outcome of each machine relative to the others.

5. A gaming system according to claim 4 wherein the adjustment is a bonus awarded by the controller at predetermined milestones during the series of individual game events, in accordance with a progressive accumulation of winnings of each machine relative to the others.

6. A gaming system according to claim 5, wherein the bonus awarded by the controller is in the form of certain amounts of additional winnings.

7. A gaming system according to claim 6 wherein the additional winnings are a proportion of a variable amount set by the controller as a competition feature win.

8. A gaming system according to claim 7 wherein a set amount of additional winnings is awarded to the machine that has the highest progressive total of winnings halfway through the series of individual game events, and the competition feature win is proportionally divided between the machines with the three highest accumulated totals at the end of the series.

9. A gaming system according to claim 4 wherein the individual game events are selected from the group of on screen simulations of black jack, dice games, and standard five reel, three row of array of symbols used in poker machines.

10. A gaming system according to claim 1 wherein the eligibility criteria by which the controller assesses which of the machines is eligible to participate in the feature are whether the machine is operating a game at the time of the trigger or less than 10 seconds has elapsed since the end of the last game, and the machine still carries player credit for continued operation.

11. A gaming system according to claim 1 wherein a percentage of the bet placed on each machine is recorded by the controller and a progressive accumulation of the percentage of the bets from all the machines is shown as a competition feature win amount on a large screen in a prominent position near the gaming machines, and wherein the competition feature win amount is initially set at a minimum value and increases whenever a bet is placed on at least one of the machines linked to the controller such that when an accumulated competition feature win value reaches a randomly selected trigger value, the controller initiates the feature game.

12. A gaming system according to claim 11 wherein the large screen shows a progressive total of the feature game winnings for each of the eligible machines.

13. A gaming system according to claim 12 wherein each of the eligible machines show the progressive totals of the feature game winnings during the feature game.

14. A gaming system according to claim 13 wherein the large screen, and each of the eligible machines, show regular updates of the feature game winnings, the number of individual game events remaining in the feature game, and a ranking of the eligible machines.

15. A gaming system according to claim 14 wherein each of the eligible machines have individualized displays highlighting its own position relative to the other eligible machines.

16. A gaming system according to claim 15 wherein the system is configured such that at the conclusion of the feature game, the gaming machine with the most feature game winnings is awarded 75% of the trigger value and the gaming machine with the next highest winnings is awarded 25% of the trigger value, unless only one of the machines was eligible to participate in the feature game, then that gaming machine is awarded 100% the trigger value is awarded, and if at least two of the gaming machines have equal highest feature game winnings, the trigger value is split equally between the those gaming machines.

17. A gaming system according to claim 16 wherein if only one gaming machine has the highest feature game winnings and at least two of the gaming machines tie for the second highest feature game winnings, then 25% of the trigger value is divided equally amongst the at least two machines.

18. A gaming system according to claim 1 wherein the feature game winnings for each machine is adjusted depending on the last amount bet on the primary game immediately prior to the initiation of the feature game.

19. A gaming system according to claim 1 wherein at least one of the eligible gaming machines are excluded from the feature game as it progresses.

20. A gaming system according to claim 19 wherein after a predetermined number of individual game events, the controller excludes at least one of the gaming machines with the lowest progressive total until only two of the gaming machines remain which complete the feature game, wherein the winner receives 75% of the trigger value and the other receives 25%.

21. A gaming system according to claim 19 wherein after predetermined number of individual game events, the controller excludes any of the machines that fail to reach a threshold level of winnings.

22. A gaming system according to claim 21 wherein the eligible gaming machines play to achieve an escalating series of winning thresholds that must be achieved within a set number of the individual game events and if any of the eligible gaming machines do not achieve these threshold, the controller excludes those gaming machine from the feature game.

23. A gaming system according to claim 22 wherein each of the thresholds has a bonus that is awarded to each machine that achieves that threshold.

24. A gaming system according to claim 23 wherein if none of the machines meet one of the thresholds, the unclaimed bonuses are added to the bonuses available when the feature game next operates.
